(19) United States
(12) Patent Application Publication
(10) Pub. No.: US 2007/0030696 A1
(43) Pub. Date: Feb. 8, 2007

(54) Backlight module having interconnected light guide plate and light source cover

(75) Inventors: Song Lv, Shenzhen (CN); Chih-Hung Chang, Miao-Li (TW); Ching-Huang Lin, Miao-Li (TW); Che-Kuei Mai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/501,521

(22) Filed: Aug. 8, 2006

(30) Foreign Application Priority Data
Aug. 8, 2005 (TW) 94213478

(51) Int. Cl. F21V 7/04

(52) U.S. Cl. 362/615

(57) ABSTRACT

An exemplary backlight module (20) includes a light guide plate (21) having an incident surface (211) and a side surface (714) between an emission surface (212) and a bottom surface (213), the bottom surface being opposite to the emission surface, the side surface being substantially perpendicular to the incident surface; a light source (22) opposite to the incident surface; and a light source cover (23) for reflecting light beams from the light source into the light guide plate. The light source cover is engaged with the light guide plate through a fastening mechanism. The light source cover surrounds one end of the light guide plate at the incident surface, thereby forming a space in cooperation with the end of the light guide plate, and the light source is received in the space.

### BACKGROUND OF THE INVENTION

1. Field of the Invention

The present invention relates to backlight modules typically used in liquid crystal displays, and more particularly to a backlight module which includes fastening means that interconnect a light guide plate and a light source cover thereof.

2. General Background

In general, liquid crystal displays (LCDs) have two main advantages in comparison with cathode ray tubes (CRTs): LCDs are thin, and have low power consumption. It has been said that LCDs might one day completely replace CRT display devices, and LCDs have aroused great interest in many industries in recent times. Because liquid crystal used in an LCD is not self-illuminating, ambient light or an accompanying backlight module is needed to illuminate the liquid crystal. Thus one kind of LCD includes a backlight module, which provides even light for a clear display.

A typical backlight module has a light source and a light guide plate. The light source may be one or more point light sources such as light-emitting diodes (LEDs), or a linear light source such as an elongate fluorescent lamp. The light guide plate has a low-profile end face through which light is introduced, and two opposite major faces one of which functions as an emission face.

The light guide plate functions to change a direction of propagation of light beams emitted from the light source and introduced into the light guide plate, from a direction roughly parallel to the emission face of the light guide plate to a direction perpendicular to the emission face. That is, the light guide plate effectively changes the point light source(s) or linear light source into a surface light source, for evenly illuminating a whole display screen of the LCD.

FIG. 11 shows a conventional backlight module 10, which includes a frame 14, a light guide plate 11, a linear light source 12 (such as an elongate fluorescent lamp), and a light source cover 13. The frame 14 receives the light guide plate 11, the linear light source 12, and the light source cover 13 therein. The light guide plate 11 has an incident surface 111, and a side surface 113 opposite to the incident surface 111. The linear light source 12 is disposed adjacent to the incident surface 111. The light source cover 13 resiliently clips end portions of four sides of the light guide plate 11 which surround the incident surface 111. The light source cover 13 and the incident surface 111 thereby cooperatively define a space therebetween. The linear light source 12 is accommodated in the space. Accordingly, light beams emitted from the linear light source 12 are prevented from leaking out from the backlight module 10 and being wasted.

However, a top part of the light source cover 13 covers only a small part of a top side of the light guide plate 11, because the top side functions as a light emission surface and must be kept as free from obstruction as possible. If the backlight module 10 is subjected to impact, dropping, shock, or vibration, the top part of the light source cover 13 is liable to slide off from the top side of the light guide plate 11. When this happens, a gap is created between the light source cover 13 and the light guide plate 11, and light leakage occurs.

A new backlight module for an LCD which overcomes the above-mentioned disadvantages is desired. In particular, what is needed is a backlight module having optical components precisely and securely positioned therein.

### SUMMARY

A backlight module includes: a light guide plate having an incident surface and a side surface between an emission surface and a bottom surface, the bottom surface being opposite to the emission surface, the side surface being substantially perpendicular to the incident surface; a light source opposite to the incident surface; and a light source cover for reflecting light beams from the light source into the light guide plate. The light source cover is engaged with the light guide plate through a fastening mechanism. The light source cover surrounds one end of the light guide plate at the incident surface, thereby forming a space in cooperation with the end of the light guide plate. The light source is received in the space.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of a backlight module according to a first embodiment of the invention.

FIG. 2 is an exploded view of the backlight module shown in FIG. 1.

FIG. 3 is a side cross-sectional view of a backlight module according to a second embodiment of the invention.

FIG. 4 is an enlarged view of a circled portion IV of FIG. 3.

FIG. 5 is a side cross-sectional view of a backlight module according to a third embodiment of the invention.

FIG. 6 is an enlarged view of a circled portion VI of FIG. 5.

FIG. 7 is a side cross-sectional view of a backlight module according to a fourth embodiment of the invention.

FIG. 8 is a side cross-sectional view of a backlight module according to a fifth embodiment of the invention.

FIG. 9 is an enlarged view of a circled portion IX of FIG. 8.

FIG. 10 is a side view of a backlight module according to a sixth embodiment of the invention.

FIG. 11 is a side cross-sectional view of a conventional backlight module.

### DETAILED DESCRIPTION OF PREFERRED EMBODIMENTS

Hereinafter, preferred embodiments of the present invention will be described in detail with reference to the accompanying drawings.

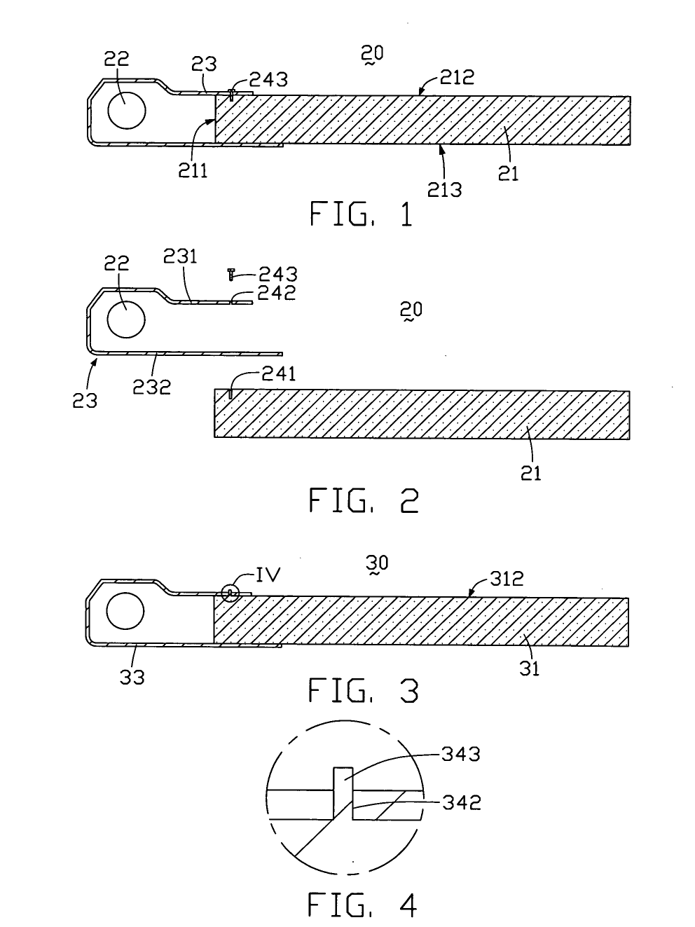

Referring to FIG. 1 and FIG. 2, a backlight module 20 according to a first embodiment of the present invention includes a light guide plate 21, a light source 22, and a light source cover 23. The light guide plate 21 includes an incident surface 211, an emission surface 212 perpendicularly connecting with the incident surface 211, and a bottom surface 213 opposite to the emission surface 212. The light source 22 can be a linear source such as an elongate fluorescent lamp, or one or more point sources such as light-emitting diodes. The light source cover 23 resiliently clips end portions of the emission surface 212, bottom surface 213, and two side surfaces (not shown) which surround the incident surface 211. The light source cover 23 and the incident surface 211 thereby cooperatively define a space therebetween. The light source 22 is accommodated in the space, opposite to the incident surface 211. The light source cover 23 is used to reflect light beams emitted from the light source 22 back to the incident surface 211 of the light guide plate 21.

The light source cover 23 includes a top holding plate 231, and a bottom holding plate 232 opposite to the top holding plate 231. The top holding plate 231 clips an end portion of the emission surface 212 of the light guide plate 21, and the bottom holding plate 232 clips an end portion of the bottom surface 213 of the light guide plate 21. In addition, the top holding plate 231 defines a through hole 242, and the light guide plate 21 at the emission surface 212 defines an aperture 241 corresponding to the through hole 242.

In assembly, the light source 22 is positioned adjacent to the incident surface 211 of the light guide plate 21. The light source cover 23 is positioned to surround substantially three sides of the light source 22, with the light source cover 23 resiliently clipping the end portions of the light guide plate 21 that surround the incident surface 211. In addition, a fastening pin 243 is provided. The fastening pin 243 extends through the through hole 242 of the light source cover 23 and is threadedly engaged in the aperture 241 of the light guide plate 21. Thereby, the fastening pin 243 helps secure the light source cover 23 to the light guide plate 21. In alternative embodiments, the fastening pin 243 may instead be interferingly engaged in the aperture 241, and/or may be adhered in the aperture 241.

In summary, the backlight module 20 has an integrated structure whereby the light source cover 23 is securely attached to the light guide plate 21. This is achieved by the extension of the fastening pin 243 through the through hole 242 of the light source cover 23 and engagement of the fastening pin 243 in the aperture 241 of the light source cover 23. Thus, the backlight module 20 has a firm structure. If the backlight module 20 is subjected to impact, dropping, shock, or vibration, the light source cover 23 resists detachment from the light guide plate 21, and no gaps are created. Therefore leakage of light beams is avoided, and the light beams emitted from the light source 22 can continue to be efficiently guided into the light guide plate 21.

FIG. 3 and FIG. 4 show a backlight module 30 according to a second embodiment of the present invention. The backlight module 30 has a structure similar to that of the backlight module 20. However, in the backlight module 30, a light guide plate 31 has a fastening pin 343 extending vertically upwardly from an emission surface 312 thereof. The fastening pin 343 corresponds to a through hole 342 defined in a light source cover 33. The fastening pin 343 is engaged in the through hole 342. Thereby, the light source cover 33 and the light guide plate 31 are securely fastened together. In particular, the fastening pin 343 may be interferingly engaged in the through hole 342, and/or may be adhered in the through hole 342.

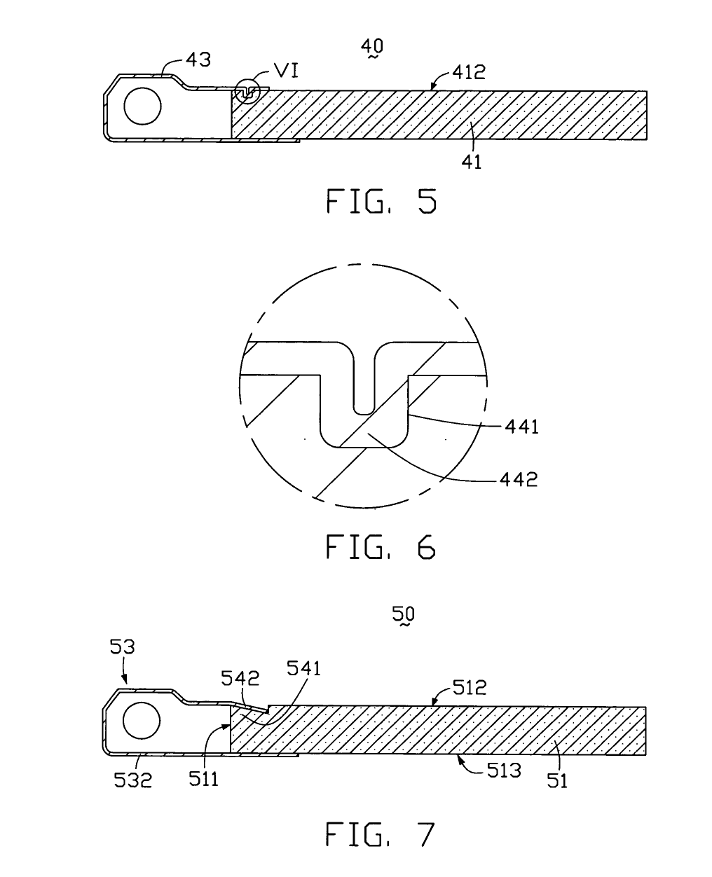

FIG. 5 and FIG. 6 show a backlight module 40 according to a third embodiment of the present invention. The backlight module 40 has a structure similar to that of the backlight module 20. However, in the backlight module 40, a light source cover 43 has a U-shaped protuberance 442 corresponding to an aperture 441 defined in a light guide plate 41 at an emission surface 412 thereof. The U-shaped protuberance 442 is engaged in the aperture 441. Thereby, the light source cover 43 and the light guide plate 41 are securely fastened together. In particular, the U-shaped protuberance 442 may be interferingly engaged in the aperture 441, and/or may be adhered in the aperture 441.

FIG. 7 shows a backlight module 50 according to a fourth embodiment of the present invention. The backlight module 50 has a structure similar to that of the backlight module 20. However, in the backlight module 50, a light guide plate 51 has a recessed portion 541 at an emission surface 512 thereof adjacent to an incident surface 511 thereof. In particular, the recessed portion 541 slants down from the incident surface 511. Thus the recessed portion 541 defines a recess having a triangular-shaped cross-section. A vertical surface of the recessed portion 541 distal from the incident surface 511 substantially perpendicularly connects with the emission surface 512. A light source cover 53 includes a top elastic holding plate 542 opposite to a bottom holding plate 532. The elastic holding plate 542 resiliently engages with the recessed portion 541, and the bottom holding plate 532 resiliently clips a bottom surface 513 of the light guide plate 51. Prior to assembly of the backlight module 50, a distance between the elastic holding plate 542 and the bottom holding plate 532 is less than a corresponding distance between the recessed portion 541 and the bottom surface 513 of the light guide plate 51. Thus, once the backlight module 50 is assembled, the elastic holding plate 542 and the bottom holding plate 532 resiliently clip an end of the light guide plate 51 at the incident surface 511.

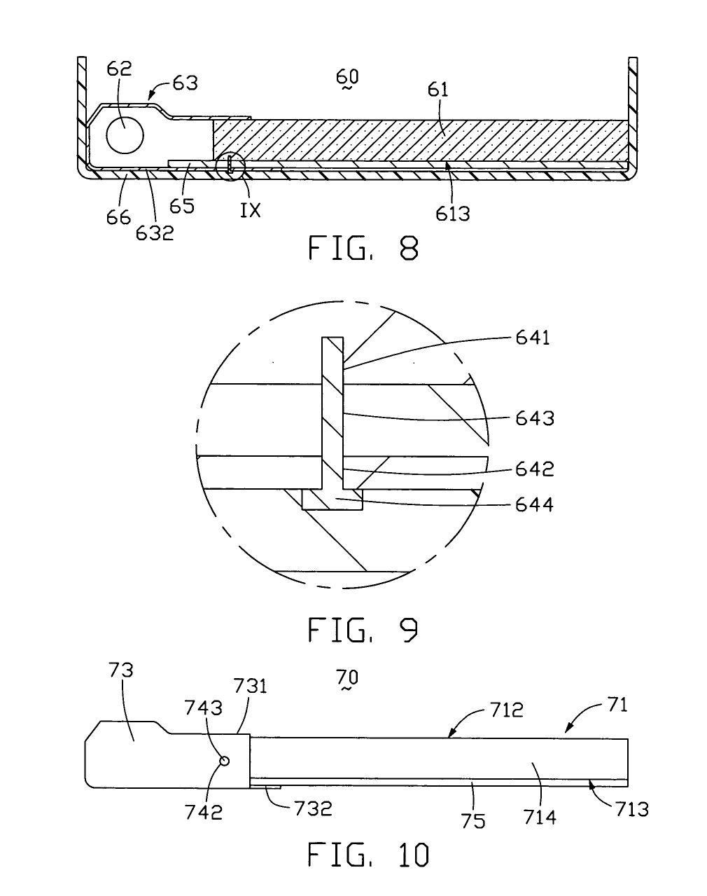

FIG. 8 and FIG. 9 show a backlight module 60 according to a fifth embodiment of the present invention. The backlight module 60 has a structure similar to that of the backlight module 20. However, the backlight module 60 further includes a reflector 65 disposed under a bottom surface 613 of a light guide plate 61, and a frame 66. The frame 66 receives the light guide plate 61, a light source 62, a light source cover 63, and a fastening pin 644 therein. The light source cover 63 surrounds one end of the light guide plate 61. The light source cover 63, a portion of the reflector 65, and an incident surface (not labeled) of the light guide plate 61 cooperatively define a space therebetween. The light source 62 is accommodated in the space. The light source cover 63 defines a through hole 642 in a bottom holding plate 632 thereof. The reflector 65 defines a through hole 643 corresponding to the through hole 642. The light guide plate 61 defines an aperture 641 at the bottom surface 613. In assembly, the reflector 65 is adhered to the bottom surface 613 of the light guide plate 61. The light source cover 63 resiliently clips one end of the combined light guide plate 61 and reflector 65, and surrounds substantially three sides of the light source 62. The fastening pin 644 extends through the two through holes 642, 643 and is threadedly engaged in the aperture 641 of the light guide plate 61. Thereby, the fastening pin 644 helps secure the light source cover 63 to the light guide plate 61. In alternative embodiments, the fastening pin 644 may instead be interferingly engaged in the aperture 641, and/or may be adhered in the aperture 641.

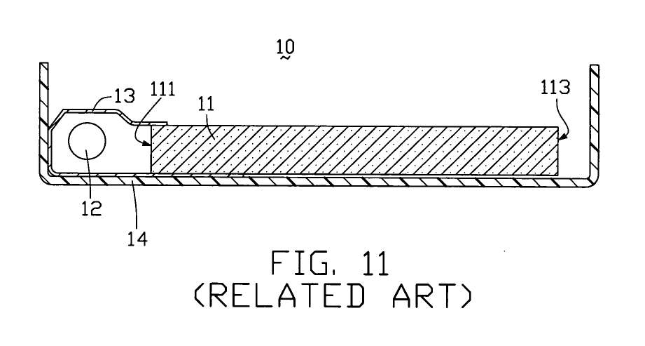

FIG. 10 shows a backlight module 70 according to a fifth embodiment of the present invention. The backlight module 70 has a structure similar to that of the backlight module 60. However, in the backlight module 70, an aperture (not visible) is defined at a side surface 714 of a light guide plate 71. The aperture is located at an end of the side surface 714 near an incident surface (not visible) of the light guide plate 71, between an emission surface 712 and a bottom surface 713 of the light guide plate 71. A through hole 742 is defined in a side wall (not labeled) of a light source cover 73, between a top holding plate 731 and a bottom holding plate 732 of the light source cover 73. A reflector 75 is adhered to the bottom surface 713 of the light guide plate 71, but there is no frame. The light source cover 73 resiliently clips one end of the combined light guide plate 71 and reflector 75, and surrounds substantially three sides of a light source (not visible). A fastening pin 743 extends through the through hole 742 and is threadedly engaged in the aperture of the light guide plate 71. Thereby, the fastening pin 743 helps secure the light source cover 73 to the light guide plate 71. In alternative embodiments, the fastening pin 743 may instead be interferingly engaged in the aperture of the light guide plate 71, and/or may be adhered in the aperture of the light guide plate 71.

It is to be further understood that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A backlight module, comprising:
a light guide plate having an incident surface and a side surface between an emission surface and a bottom surface, the bottom surface being opposite to the emission surface, the side surface being substantially perpendicular to the incident surface;
a light source opposite to the incident surface; and
a light source cover for reflecting light beams from the light source into the light guide plate;
wherein the light source cover is engaged with the light guide plate through a fastening mechanism, the light source cover surrounds one end of the light guide plate at the incident surface thereby forming a space in cooperation with the end of the light guide plate, and the light source is received in the space.

2. The backlight module of claim 1, wherein the fastening mechanism comprises a fastening pin, which extends through a through hole of the light source cover and is engaged in an aperture of the light guide plate.

3. The backlight module of claim 2, wherein the through hole is provided at a top holding plate of the light source cover, and the aperture is provided at the emission surface of the light guide plate.

4. The backlight module of claim 2, wherein the through hole is provided at a bottom holding plate of the light source cover, and the aperture is provided at the bottom surface of the light guide plate.

5. The backlight module of claim 2, wherein the through hole is provided at a sidewall of the light source cover, and the aperture is provided at the side surface of the light guide plate.

6. The backlight module of claim 2, further comprising a reflector disposed under the bottom surface of the light guide plate.

7. The backlight module of claim 6, wherein the fastening pin also extends through a through hole of the reflector.

8. The backlight module of claim 1, wherein the fastening mechanism comprises an elastic holding plate of the light source cover and a recessed portion of the light guide plate adjacent to the incident surface, wherein the elastic holding plate of the light source cover resiliently holds the recessed portion of the light guide plate.

9. The backlight module of claim 8, wherein the recessed portion defines a triangular cross-section.

10. The backlight module of claim 1, wherein the fastening mechanism comprises a fastening pin extending vertically upwardly from the emission surface of the light guide plate, and the fastening pin is engaged in a through hole of the light source cover.

11. The backlight module of claim 1, wherein the fastening mechanism comprises a U-shaped protuberance of the light source cover, and the U-shaped protuberance is engaged in an aperture of the light guide plate.

12. A backlight module, comprising:
a light guide plate defining an edge region;
a light source positioned along said edge region; and
a light source cover enclosing the light source except in a direction facing to said edge region for reflecting light beams;
wherein the light source cover is fastened to the light guide plate along said edge region so as to prevent relative movement between the light source cover and the light guide plate in said direction.
